(19) United States
(12) Patent Application Publication
(10) Pub. No.: US 2025/0159007 A1
(43) Pub. Date: May 15, 2025

(54) SYSTEM AND METHOD FOR TELEMETRY DATA BASED EVENT OCCURRENCE ANALYSIS WITH ADAPTIVE RULE FILTER

(71) Applicant: Virsec Systems, Inc., San Jose, CA (US)

(72) Inventors: Sanjay Kumar, Bangalore (IN); Manoj Paul, San Jose, CA (US)

(21) Appl. No.: 18/714,827

(22) PCT Filed: Dec. 2, 2022
(86) PCT No.: PCT/US2022/080826

§ 371 Date: May 30, 2024

Related U.S. Application Data
(60) Provisional application No. 63/267,069, filed on Jan. 24, 2022.

(30) Foreign Application Priority Data
Dec. 2, 2021 (IN) 202141055853

(51) Int. Cl. H04L 9/40

(52) U.S. Cl. CPC H04L 63/1425; H04L 63/1416

(57) ABSTRACT

Embodiments determine event, e.g., security breach, etc., occurrence based on telemetry data. One such method receives telemetry data, e.g., data based on an HTTP transaction, and a rule associated with the telemetry data. The rule defines at least one perimeter filter and at least one deep filter for processing the telemetry data. In turn, a rule engine is modified in accordance with the received rule. The modified rule engine is configured to automatically switch between the at least one perimeter filter and the at least one deep filter. The received telemetry data is processed with the modified rule engine to determine event occurrence.

### RELATED APPLICATIONS

This application claims the benefit of U.S. Provisional Application No. 63/267,069, filed on Jan. 24, 2022.

This application claims priority under 35 U.S.C. § 119 or 365 to Indian Provisional Application No. 202141055853, filed Dec. 2, 2021.

The entire teachings of the above applications are incorporated herein by reference.

### BACKGROUND

Hypertext Transfer Protocol (HTTP) is a popular standard protocol widely used by the World Wide Web to facilitate transfer of information between clients (such as Internet browsers) and web/application servers. The HTTP protocol defines how messages are formatted and transmitted, and what actions web/application servers and browsers should take in response to various commands indicated by HTTP formatted messages. Typically, telemetry data is generated at web/application servers that record HTTP interactions (and resulting actions and commands) between web/application servers and their clients. Traditionally, this telemetry data is collected in the form of web logs for later processing, but more sophisticated implementations may instrument an HTTP pipeline at web/application servers to extract this telemetry information in real-time. Telemetry data is very useful to run offline or real-time analytics for purposes of Application Performance Monitoring (APM), enforcing web application security, and/or deriving actionable business intelligence.

### SUMMARY

Many tools already exist that provide the capability to triage recorded or real-time HTTP telemetry data. However, these existing tools are based on fixed function implementations. Fixed functions are just that, fixed, i.e., cannot be changed without modifying and recompiling the code implementing the function. As such, fixed functions are written to receive a particular input, perform particular processing, and provide a particular output. If you want to change the input, processing, or output of the function you need to change the function itself, i.e., the source code of the function, and this new code must be re-compiled. As such, adding new capabilities to existing telemetry data triaging tools typically requires either enhancements to existing fixed function implementations or writing entirely new functions themselves. Accordingly, rolling out new capabilities in such HTTP telemetry data processing and analysis tools requires software upgrades. This lack of flexibility provided by existing telemetry data tools is problematic.

Applicant's pending U.S. patent application Ser. No. 17/649,225, entitled “System and Method For Telemetry Data Based Event Occurrence Analysis With Rule Engine,” the contents of which are herein incorporated by reference in their entirety, and referred to herein as “the '225 patent application,” provides a solution to the aforementioned problem through implementation and use of a new flexible rule-engine based approach where implementing a new HTTP telemetry data processing function is as easy as writing a rule/set of rules. The functionality provided by the '225 patent application can adapt to handle different input and provide different processing and output by simply changing the rules. In this way, certain aspects described in the '225 patent application can provide different processing of telemetry data without changing code and re-compiling. This makes the functionality significantly more flexible than existing methods. According to an aspect, such rules are written according to a pre-defined syntax and can be readily submitted to a rule-engine to execute. The execution of these rules by the rule-engine provides the same functionality provided by current fixed function implementations, but without requiring any need for software upgrades.

Applicant's '225 patent application introduced the notion of a programmable Rule Engine which (i) accepts rules that are written in a pre-defined grammar and (ii) handles HTTP transactional telemetry data. This processing of telemetry data may be aimed at any use case, including enforcing runtime security of application servers, application performance monitoring, and deriving any desired actionable business intelligence. Rules that are processed by the aforementioned rule engine are often structured using filters and events, amongst other examples.

In an example use of the rule engine, rule filters implement web security algorithms which can be dynamically enabled, disabled, or upgraded. These filters work on web events such as HTTP requests, HTTP responses, and other events which are part of backend application processing such as database queries, executing commands, or file operations, amongst other examples. Typically, rule filters need these messages to correctly identify any malicious attempt from the user in an efficacious manner with minimal false positives.

Events such as executing commands (e.g., sh/ipconfig/cat), querying databases (e.g., postgres SQL statements), or operating on files (e.g., read/write), etc., are executed by backend applications while processing HTTP requests. Applications may use framework application programming interfaces (APIs) to execute these events. For rule filters, such as those described in the '225 patent application, to work successfully, these events should be intercepted by instrumenting application framework APIs. However, amongst other examples, applications may choose to use different database or third-party libraries to execute these events and, as such, it is not always possible to instrument third party libraries, or support all variants of database APIs. In those cases, rule filters, such as those described in the '225 patent application, may not be able to successfully determine event occurrence, e.g., detect malicious actions.

The present disclosure solves this problem.

An example implementation is directed to a computer-based method for determining event occurrence based on telemetry data. One such method begins by receiving telemetry data and a rule associated with the telemetry data. The rule defines at least one perimeter filter and at least one deep filter for processing the telemetry data. In turn, a rule engine, e.g., a generic rule engine, is modified in accordance with the received rule. The modified rule engine is configured to automatically switch between the at least one perimeter filter and the at least one deep filter. The received telemetry data then is processed with the modified rule engine to determine occurrence of an event, i.e., if an event will occur, is occurring, or occurred.

In certain aspects of the present disclosure, the telemetry data is based upon multiple different events/actions. For instance, the telemetry data can be based on a HTTP transaction, processing the HTTP transaction, and/or multiple HTTP transactions.

According to an aspect, the telemetry data includes at least one of: perimeter-type data and deep-type data. Where the telemetry data includes multiple types of data, processing the received telemetry data can include selecting one or more filters, from amongst the at least one perimeter filter and the at least one deep filter, based on data types comprising the telemetry data. The telemetry data is then processed with the selected one or more filters. In an implementation, selecting the one or more filters includes, responsive to the telemetry data including only the perimeter-type data, selecting both the at least one perimeter filter and the at least one deep filter and, responsive to the telemetry data including only the deep-type data or both the perimeter-type data and the deep-type data, disabling the at least one perimeter filter and selecting the at least one deep filter.

According to yet another aspect, processing the received telemetry data with the modified rule engine identifies which of the at least one perimeter filter and at least one deep filter are activated in processing the received telemetry data. In such a method, event occurrence is determined based on the identified activated filters.

In aspects of the present disclosure, the rule is constructed and defined in accordance with a grammar. Further still, according to another aspect, determined events may include a performance degradation, a security breach, a hijacked session, and a behavior defined by the rule, amongst other examples. Moreover, the processing may determine occurrence of the event in real-time.

Another aspect of the present disclosure is directed to a system that includes a processor and a memory with computer code instructions stored thereon. The processor and the memory, with the computer code instructions, are configured to cause the system to implement any functionality or combination of functionality described herein.

Yet another aspect of the present disclosure is directed to a cloud computing implementation to determine event occurrence, i.e., if an event is occurring, will occur, or occurred, based on telemetry data. Such an aspect is directed to a computer program product executed by a server in communication across a network with one or more clients. The computer program product comprises instructions which, when executed by one or more processors, causes the one or more processors to implement any functionality or combination of functionality described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flowchart of a method for determining event occurrence based on telemetry data according to an embodiment.

FIG. 2 is a flowchart of a method for processing telemetry data according to an example implementation.

FIG. 3 is a flowchart for processing telemetry data based on data types in an example implementation.

FIG. 4 depicts a system for processing telemetry data through filters according to an embodiment.

FIG. 5 is a block diagram of a computer-based engine implementing an example embodiment.

FIG. 6 is a graphical illustration of a system implementing an event profile according to an embodiment.

FIG. 7 depicts a system utilizing event profiles in an embodiment.

FIG. 8 depicts a system utilizing namespaces in an embodiment to process telemetry data to determine event occurrence.

FIG. 9 is a simplified block diagram of a computer system for processing telemetry data according to an embodiment.

FIG. 10 is a simplified block diagram of a computer network environment in which embodiments of the present invention may be implemented.

### DETAILED DESCRIPTION

A description of example embodiments follows.

When an application server, i.e., web server, receives a HTTP request from a client, the application server handles the request based on the Uniform Resource Locator (URL). The URL is specified as one of the header fields in a HTTP request and the URL refers to a resource located on the application server. Multiple actions may be performed by an application server as part of handling an HTTP request. These actions may include performing local/remote file read/write operations, invoking local system commands, and performing operations on backend database(s), amongst other examples. These actions typically conclude with an application server generating an HTTP response that is sent back to the client. A sophisticated telemetry agent can instrument various software methods involved in performing the aforementioned actions and generate data related to each of these actions. A more trivial implementation may extract telemetry data from web logs. Irrespective of the method, telemetry data of an HTTP transaction is associated with a well-defined sequence of steps, as outlined below. Some steps are optional and depend on a web/application server's logic, e.g., business logic.

Step 1—HTTP Request: HTTP request is the first message that is sent by a client (such as an internet browser) to a web/application server. An HTTP request includes header and body fields. Both header and body fields can be part of telemetry data. Examples of telemetry data collected during an HTTP request event include: URL, HTTP method, HTTP request header fields (e.g., Content-Type), HTTP request body (e.g., user supplied data), and time of HTTP request arrival, amongst other examples.

Step 2—File Read/Write (Optional): Application code may perform read/write of local or remote files as part of handling an incoming HTTP request. Telemetry data associated with such an event may include: file path, file name, remote URL, and read/write operation, amongst other examples.

Step 3—Operating System (OS) Calls (Optional): Application code may invoke some local operating system calls as part of HTTP request processing. Telemetry data associated with this event may include system command(s) that are being invoked, amongst other examples.

Step 4—Database Queries (Optional): Applications that use some backend database may invoke database queries as part of HTTP transaction handling. These databases may be SQL or noSQL type databases. Telemetry data associated with database queries may include the actual query being made by application code, response status of the query, and actual database content returned by the backend database, amongst other examples.

Step 5—HTTP Response: An HTTP transaction concludes with generation and transmission of an HTTP response. The HTTP response includes header and body fields. Telemetry data associated with a HTTP response may contain the header and body content and timestamp of transmission, amongst other examples.

In addition to the foregoing data, telemetry data may also include data that indicates the context of the HTTP transaction associated with the telemetry data. For instance, the aforementioned steps (or subsets thereof) from a given HTTP transaction can be tied together, i.e., grouped, in a context. For example, a unique HTTP transaction ID may be assigned to messages (e.g., the data from steps 1-5) from a given HTTP transaction. Telemetry data sent for each of these messages can be grouped by stamping each message with this unique HTTP transaction ID. Similarly, there is a notion of a client session (for example, an internet browser session)—that may include multiple HTTP transactions. A different unique ID, e.g., Session ID, may be assigned to all HTTP transactions within a given session. Telemetry data sent for each of these HTTP transactions can be stamped with the same Session ID.

Embodiments of the present disclosure provide a flexible rule-based finite automaton that consumes telemetry data from the above-mentioned HTTP transaction messages in real-time and produces a final state of interest. Example final states of interest include determination of an HTTP transaction as not conforming with defined performance characteristics, e.g., transaction time, classification of an HTTP transaction as a security breach, or classification of a client session as a hijacked session, amongst other examples. Advantageously, embodiments enhance the definition of rule filters, such as those described in the '225 patent application, and provide a mechanism through which events, e.g., attacks or threats to web applications, are identified, even when it is not possible to instrument granular level database query, command events, or file operations during HTTP transaction processing.

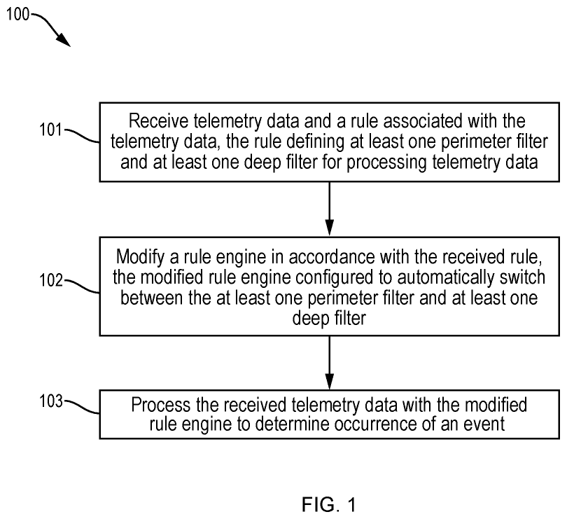

FIG. 1 is a flowchart of one such example method 100 that processes telemetry data to determine event occurrence. The method 100 starts at step 101 by receiving telemetry data and a rule associated with the telemetry data. The rule received at step 101 defines at least one perimeter filter and at least one deep filter for processing the telemetry data. In embodiments, a perimeter filter operates on perimeter event data, e.g., HTTP requests and responses, whereas a deep filter can operate on both perimeter event data and deep event data, e.g., events related to commands, database transactions, file events, etc., that result from HTTP requests and responses (perimeter event data). The method 100 is computer implemented and, as such, the telemetry data and rule may be received from any point or data storage memory communicatively coupled to the computing device implementing the method 100. To continue, at step 102, a rule engine is modified in accordance with the received rule. The modified rule engine is configured to automatically switch between the at least one perimeter filter and the at least one deep filter. In other words, such a rule engine is modified to selectively use the at least one perimeter filter and/or at least one deep filter. According to an embodiment, the rule engine modified at step 102 includes a computer program that is configured to understand and process the rule defined in step 101. A rule engine also maintains runtime state that results from execution of rules using its computer program. While the computer program of the rule engine does not change, the runtime state is updated as part of step 102. In turn, at step 103, the received telemetry data is processed with the modified rule engine to determine occurrence of an event, i.e., if an event will occur, is occurring, or has occurred. Step 103 can entail the rule engine executing the rule from step 101 on telemetry data to ascertain occurrence of certain event(s) based on result(s) of executing the rule.

In embodiments of the method 100, the telemetry data received at step 101 can be based upon multiple different events/actions. For instance, the telemetry data can be based on a HTTP transaction, processing an HTTP transaction, and/or multiple HTTP transactions. As such, in embodiments, the telemetry data can be based on HTTP messages and also associated system events involved in, or resulting from, processing an HTTP message. These system events may include database reads, database writes, system service function calls, and local and remote file reads and writes.

The rule or rules received at step 101 are constructed and defined in accordance with a grammar. In an embodiment, the grammar dictates keywords and syntax on how a rule should be constructed. In addition to defining one or more filters for processing telemetry data, rules can also define: (i) output of a first filter utilized by a second filter, (ii) an event profile comprising a group of filters or sequence of filters, (iii) a feature comprising one or more event profiles, and/or (iv) a namespace comprising one or more features. In an embodiment of the method 100, event profiles, features, and namespaces serve as constructs for organizing filters and, specifically, define how filters process telemetry data. Further details regarding filters, event profiles, features, and namespaces that may be utilized in embodiments of the method 100 are described hereinbelow.

The method 100 may detect a plurality of different events. Determined events may include any desired user configured event. For example, determined events may include a defined level of performance degradation in application code or backend database, crossing a threshold to log specific messages of an HTTP transaction, a security breach, a hijacked session, and a behavior defined by the rule, e.g., an unexpected or undesirable behavior, amongst other examples. Moreover, the processing at step 103 may determine event occurrence in real-time or may determine if an event occurred in the past.

In an embodiment of the method 100, the telemetry data received at step 101 includes at least one of: perimeter-type data and deep-type data. According to an embodiment, perimeter-type data includes HTTP Requests and HTTP Responses and deep-type data includes system commands, database transactions, and local and remote files read/writes. In such an embodiment where the telemetry data includes multiple types of data, processing the received telemetry data at step 103 can include selecting one or more filters, from amongst the at least one perimeter filter and the at least one deep filter. According to an embodiment, the selecting is based on data types comprising the telemetry data. Such an embodiment processes the telemetry data at step 103 with the selected one or more filters.

In an example implementation of the method 100, selecting the one or more filters includes, responsive to the telemetry data including only the perimeter-type data, selecting both the at least one perimeter filter and the at least one deep filter and, responsive to the telemetry data including only the deep-type data or both the perimeter-type data and the deep-type data, disabling the at least one perimeter filter and selecting the at least one deep filter. Thus, in such an example embodiment, if the telemetry data includes deep-type data, the telemetry data (which includes perimeter-type data and deep-type data or just deep-type data) is processed with a deep-type filter.

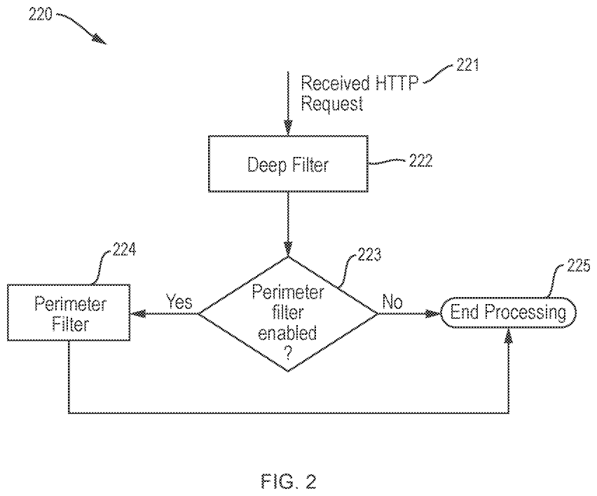

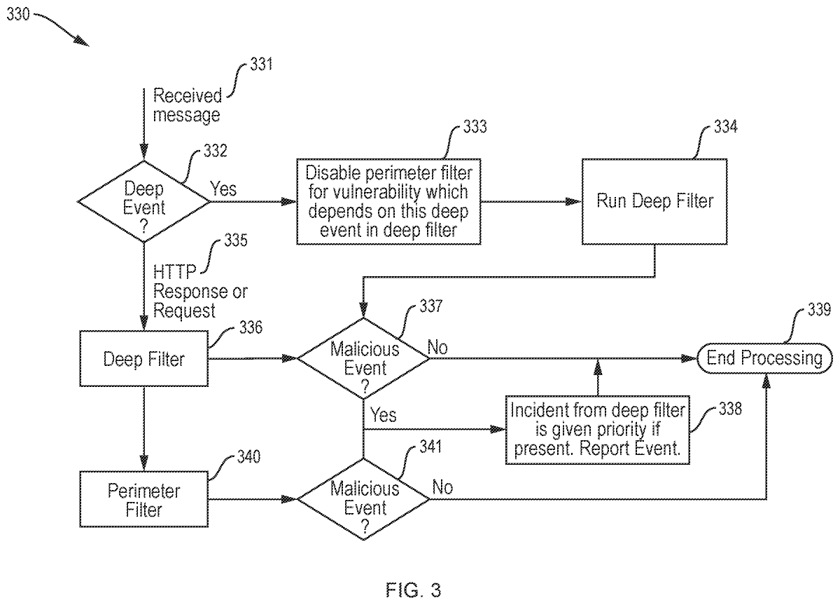

Further, embodiments of the method 100 may implement the methods 220 and/or 330 described hereinbelow in relation FIGS. 2 and 3, respectively, at step 103 to process the telemetry data so as to determine event occurrence.

According to yet another aspect, processing the received telemetry data with the modified rule engine at step 103 identifies which of the at least one perimeter filter and at least one deep filter are activated in processing the received telemetry data. In such a method embodiment, event occurrence is determined at step 103 based on the identified activated filters.

Embodiments of the method 100 may utilize a rule engine that implements and employs a finite state automaton, i.e., finite state machine, to determine occurrence of an event. In such an embodiment of the method 100, modifying the rule engine at step 102 in accordance with the rule (received at step 101) comprises defining functionality of the finite state automaton implemented by the rule engine in accordance with the received rule, i.e., defining an internal state of the finite state automaton. This may include, for example, defining a state related to match/no match of telemetry data to a predefined set of regular expressions that are part of the rule received at step 101. For instance, the rule engine may run a rule that comprises performing a regular expression based search for a pre-defined set of patterns in telemetry data, and determining a state in the finite state machine about match/no-match of any pattern in telemetry data. Advantageously, in such an embodiment, the functionality of the finite state automaton is defined without needing to perform an image upgrade, i.e., performing a software update. In an embodiment, the finite state automaton is driven by the rule received at step 101 and, as such, an update to the rule is sufficient to achieve detection of a new class of events at step 103 by the rule engine modified at step 102. Comparatively, fixed function solutions require an update to their computer program in order to detect a new class of events. Such an embodiment processes the telemetry data at step 103 with the finite state automaton to determine event occurrence.

To illustrate an embodiment of the method 100, consider a simplified example where telemetry data from an HTTP transaction with the URL www.myspace.com is received at step 101. The rule received at step 101 indicates that all telemetry data resulting from HTTP transactions with the URL www.myspace.com are processed through filter1 and, then, filter2 or filter3 depending on the output of filter1, and, if processing the telemetry data activates filter3, the HTTP transaction (that the telemetry data is based on) satisfies a user configured event condition, e.g., according to the definition set by the user the HTTP transaction is causing a security breach or is not in compliance with desired performance quality (amongst other examples). Upon receiving this telemetry data and the rule at step 101, the rule engine is modified at step 102 in accordance with the rule. According to an embodiment, the rule engine program remains unchanged, but the state maintained in the rule engine is modified as the rule from step 101 is applied to telemetry data. At step 103, the telemetry data is processed with the modified engine and if filter1 and filter2 are activated it is determined that no event is occurring and if filter1 and filter3 are activated it is determined that the user configured event is occurring, e.g., a security breach is occurring or performance fell below a desired metric.

Embodiments enhance the definition of rule filters, such as those described in the '225 patent application, and provide a mechanism through which events, e.g., attacks or threats to web applications, are identified, even when it is not possible to instrument granular level database query, command events, or file operations during HTTP transaction processing.

In an embodiment, rule filters, broadly, depend on two kinds of HTTP telemetry data from application instrumentation, (i) perimeter events and (2) deep events. According to an example embodiment, perimeter events include HTTP request and HTTP response events. These perimeter events are generated whenever a HTTP request is received by a web application and an HTTP response is generated by the web application's processing of the HTTP request. Perimeter telemetry events are directly mapped to HTTP request and HTTP response messages. Generally, perimeter telemetry events are available via web application framework instrumentation. Deep events include file operations, command executions, and database queries, amongst other examples. Deep telemetry events are a result of deep instrumentation of APIs that web applications may use to process a HTTP request. To elaborate, telemetry data is generated by instrumentation of various steps in a HTTP transaction pipeline. Instrumenting at a “granular” level, i.e., “deep instrumentation,” means an ability to generate telemetry data of “deeper” events of an HTTP transaction, such as, system commands, database transactions, local and remote file reads/writes events. Deep instrumentation can include hooking methods in application frameworks that can help retrieve telemetry data from an HTTP transaction pipeline. Deep instrumentation, specifically, refers to hooking for “deeper events” such as system commands, database transactions, and local and remote file read/write methods.

Depending on web application processing logic, a HTTP transaction may not have any deep events such as system command calls, database transactions, and local and remote reads or writes. Further, these deep events may not become available in telemetry data due to a lack of instrumentation of APIs used by a web application in question.

An embodiment classifies filters, i.e., rule filters, as perimeter filters and deep filters. In one such embodiment, perimeter filters only depend on perimeter events whereas deep filters additionally depend on one or more deep events (and optionally perimeter data as well). In an embodiment, if only perimeter data is available, the perimeter data is processed by both a perimeter filter and deep filter. However, if only deep data or both deep data and perimeter data are available, the data is processed by only a deep filter. Availability of deep events and deep filters typically results in a more accurate detection of an event, e.g., attack/threat event.

According to an embodiment, two sets of rule filters are utilized for each security control, namely, perimeter filters and deep filters. As the names suggests, perimeter filters process perimeter events whereas deep filters process both deep events and perimeter events. In an embodiment, perimeter type telemetry data (perimeter events), such as HTTP requests and HTTP responses are passed through both types of filters (perimeter filters and deep filters) whereas deep type telemetry data (deep events) pass only through deep filters. In other words, perimeter filters operate on perimeter events (e.g., HTTP Requests and Responses), whereas Deep filters can operate on both perimeter events (e.g., HTTP Requests and Responses) as well as Deep events (e.g., system commands, database transactions, local and remote file read/writes).

According to an embodiment, for each security control implemented using a rule engine infrastructure, there is a set of rule filters that are of perimeter type as well as deep type. As mentioned above, deep filters would typically result in detection of event, e.g., attack/threat, occurrence with more precision compared to perimeter filters.

For a given URL, deep events (e.g., command execution, database query, file operations, etc.) are typically generated as part of telemetry events if an application performs corresponding tasks as part of handling a HTTP request. There are two possibilities as to why a deep event may not be generated: (1) there is no such task performed by an application while processing a HTTP request for a given URL, or (2) deep instrumentation is not available and, therefore, no corresponding telemetry event can be produced even though the application did execute those tasks (deep tasks) while processing the HTTP request for a given URL.

According to an embodiment, in the beginning, i.e., upon receiving an HTTP request from a client as indicated by a URL, both sets of filters (perimeter and deep) are enabled for each security control. In an embodiment, security controls refer to specific security vulnerabilities that rule filters hope to identify in an HTTP transaction. Examples of such security controls include, a Reflected Cross Site Scripting vulnerability and a SQL Injection vulnerability, amongst other examples. Whenever a deep event (such as DB query, command execution, or file operation, amongst others) is received, it is assumed that instrumentation for any corresponding event is successful regardless of the URL. In such a case, perimeter filters corresponding to the security control are disabled for all URLs of the web application in question. For example, if a rule engine receives a SQL deep event, then one or more perimeter filters corresponding to SQL injection security control are disabled for all URLs of the web application in question. An embodiment provides an indication of the determined event, e.g., an incident report, at the time of the HTTP response.

FIG. 2 illustrates a method 220 for determining event occurrence according to an embodiment. The method 220 begins with receiving an HTTP request 221. The HTTP request 221 is processed through the deep filter 222 and it is determined if the deep filter 222 is activated by processing the HTTP request 221. Next, at 223, the method 220 determines if a perimeter filter is enabled. If the perimeter filter is enabled (yes at 223) the method 220 moves to 224. At 224, the HTTP request 221 is processed by the perimeter filter 224 to determine if the perimeter filter 224 is activated. After processing by the perimeter filter 224, the method 220 ends 225. Likewise, if, at step 223, the method 220 determines that the perimeter filter is not enabled (no at step 223), the method 220 ends 225. When processing of the data, e.g., HTTP request 221, ends the method 220 determines if an event occurred based on the processing. Specifically, such an embodiment determines which of the filters used in the processing, the deep filter 222 and perimeter 224 (if the perimeter filter 224 is enabled) or only the deep filter 222 (if the perimeter filter is disabled), are activated and, based on this determination, identifies if an event occurred.

In an embodiment, HTTP requests are processed by both sets of filters, (deep filters and perimeter filters) for vulnerabilities, until perimeter filters are disabled for the security control. To illustrate, consider an example for SQLi. When a HTTP request is processed, the HTTP request gets processed through a HTTP request deep filter as well as a HTTP request perimeter filter. The states, e.g., an indication of whether the filters are activated, are saved in the engine. Next, it is determined whether a perimeter filter will be disabled or not. For example, if a next event is a database query message (a deep event), then, the HTTP request perimeter filter is disabled and the database query message event is processed through a database query deep filter, which may use states from the HTTP request deep filter. Deep SQLi incident (i.e., an indication that there is a SQLi attack) is generated if any malicious intent is found in the database query event (which may refer to states from the HTTP request deep filter). When the next event is not a database query, but instead a HTTP response, then the perimeter filter for SQLi remains enabled, and the perimeter SQLi incident may get generated based on HTTP request perimeter filter processing (along with/without HTTP response perimeter filter).

Perimeter filters are disabled when corresponding deep (indirect) events are received for the security control in question. FIG. 3 illustrates one such example embodiment 330.

The method 330 begins with a received message 331, i.e., telemetry data. To continue, at 332, the method 330 determines if the data 331 is an indirect event, i.e., deep event. If the data 331 is a deep event (yes at 332), the method 330 moves to step 333 where the perimeter filter for the event, e.g., vulnerability, being tested is disabled. In an embodiment, at step 333, a perimeter filter is disabled for every security control, i.e., vulnerability, upon receiving a deep event for which there is an existing deep filter. Next, at 334 the deep filter is used to process the data 331. Returning to step 332, if step 332 determines that the data 331 is not an indirect event (no at step 332), the data is a HTTP response or HTTP request 335 and this data 335 is processed by a deep filter at 336. From both steps 334 and 336, results of processing the data (indirect data if at step 334 and HTTP response or request if at step 336) are evaluated at step 337 to determine event occurrence, e.g., was there at malicious event. According to an embodiment, the evaluation at step 337 determines if the filter applied at 334 or 336 may result in an outcome about the transaction as malicious (attack or threat). If 337 determines the event occurred (yes at 337), the method 330 moves to step 338. If 337 determines a malicious event did not occur (no at 337), the method 330 ends 339. Returning to step 336, after processing the data 335 with the deep filter at 336, the method 330 also processes the data 335 with the perimeter filter 340. Results from the perimeter filter 340 processing are then evaluated at 341. If 341 determines the event, e.g., malicious event, did not occur (no at 341), the method 330 moves to step 339 and ends. If the analysis at 341 determines the event did occur (yes at 341), the method 330 moves to 338. Step 338 creates an incident report, e.g., indication that the event did occur and provides this report to a user, before ending 339 the method 330. At step 338, the incident report provides an indication of how the determination was made. Specifically, there are three possible scenarios for arriving at step 338: (1) processing of deep data, i.e., indirect event, by deep filter 334, (2) processing of direct, i.e., perimeter, data 335 by deep filter 336, or (3) processing of direct, i.e., perimeter, data 335 by perimeter filter 340. At step 338, the method 330 indicates the basis, i.e., the path used, for the determination that the event occurred. Moreover, if multiple paths lead to step 338, which can occur from the aforementioned paths (2) and (3), the incident report gives priority to path (2).

Embodiments may implement various constructs to process telemetry data so as to determine event occurrence. Hereinbelow are definitions of constructs that be may be employed in embodiments. These constructs (definitions below) can be put together to describe an embodiment of the disclosure as a rule-based finite state automaton.

### Filter

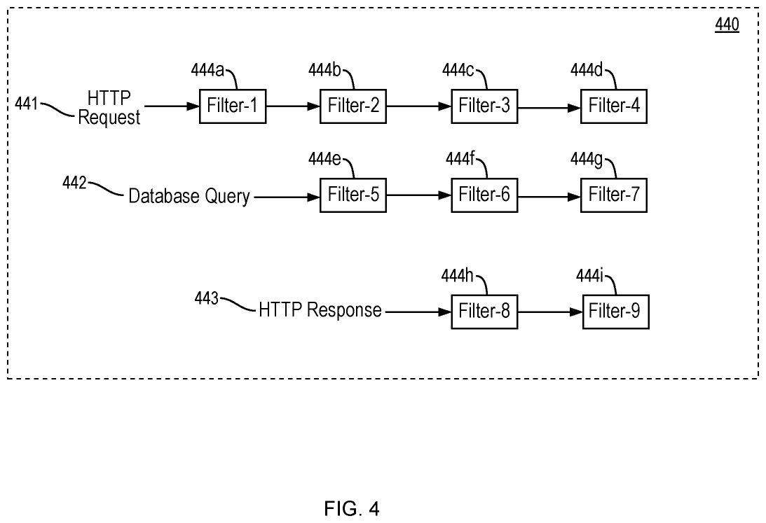

Filters are a logical construct, implemented as a set of statements to analyze an HTTP transaction message and detect a specific condition. In an embodiment of the present disclosure, a filter becomes active whenever a defined condition of that filter is met. Embodiments apply filters to specific HTTP transaction message(s). FIG. 4 illustrates an example system 440 where HTTP transactional messages 441, 442, and 443 go through a defined set of filters 444a-i to determine event occurrence. In the system 440, the HTTP request 441 is processed by the filters 444a-d. Likewise, the database query 442 is processed by the filters 444e-g and the HTTP response 443 is processed by the filters 444h-i.

Each filter, e.g., the filters 444a-i, has properties which define behavior of the variables within the filter's namespace. Filter properties that may be used in embodiments include life, message type, and filter pattern database, amongst other examples. Life defines lifetime of a filter and the filter's state variables. State variables can be valid for the duration of an HTTP transaction ID lifetime, Session ID lifetime, or a customized lifetime. Message type defines message type(s) for which a filter is valid. Messages can be valid for one or more of the HTTP transactional messages, such as HTTP request, HTTP response, and database query, etc. An embodiment utilizes a filter pattern database that defines a set of patterns, typically in PERL compatible regular expression language. This pattern database is looked up by systems implementing embodiments, e.g., a rule engine, whenever a filter in question is applied on a HTTP transactional message(s) of interest.

An example of a filter definition, i.e., rule, is given below:

FILTER httpreq_filter_myregexdb(life = http_transaction_unique_id, msg = HTTP_REQ,
dbname=myregexdb) {
.........
return somevariable;
}

The above filter is defined to detect occurrence of a pattern from provided myregexdb in an HTTP transaction. The filter has lifetime of an HTTP transaction, is applicable to HTTP request type messages and has a reference to a pattern database (myregexdb) used for lookup when this filter is applied.

An example of another filter definition is given below:

FILTER httpreq_filter_crlf(life = http_transaction_unique_id, msg = HTTP_REQ,
dbname=dbcrlf) {
.........
return somevariable;
}

This filter is defined to detect a Carriage Line Return Feed (CRLF) violation in an HTTP transaction. The filter has lifetime of an HTTP transaction, is applicable to HTTP request type messages and has a reference to a pattern database (dbcrlf) used for lookup when this filter is applied.

Each filter exports a final state after the filter finishes execution. This final state is a collection of various variables that may get set as filter execution occurs and may be stored in local or remote memory storage by a system implementing the filter. This final state data can be imported by any other filter, as required or desired. Ability to export and import states among various filters allows implementation of complex functionality that may span across multiple HTTP transactional messages.

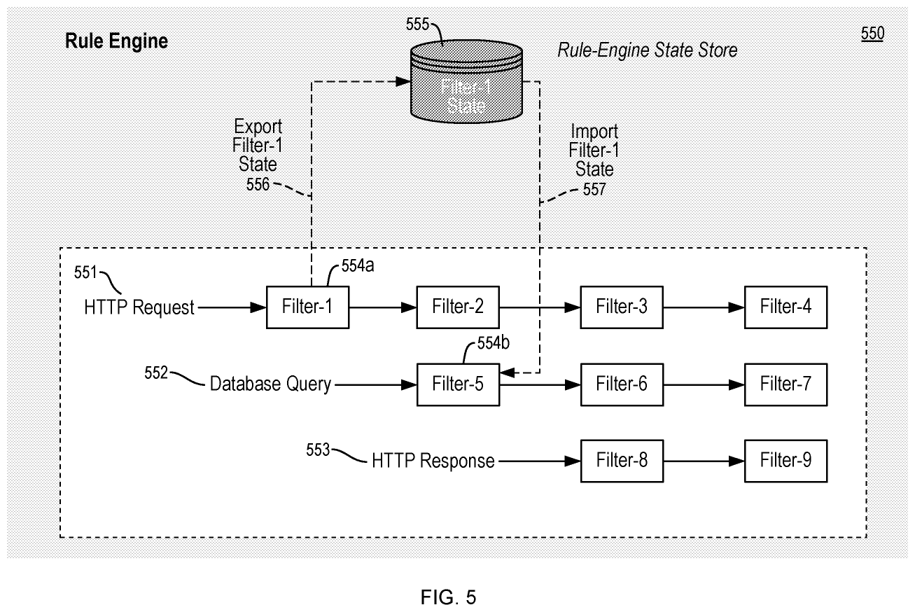

FIG. 5 shows one implementation in the rule engine 550 where states are exported and imported among filters. In the rule engine 550, the filter 554a state 556 is exported to Rule-Engine state store 555. Data from the Rule-Engine state store 555 can be utilized by any of the filters. For instance, FIG. 5 illustrates the state data 557 (which may be the state of the filter 554a) being imported by the filter 554b. This interaction allows for variables set by the filter 554a when processing the HTTP request message 551 to be used later when the rule engine 550 processes the database query 552 using the filter 554b. Such functionality allows states, i.e., variables, resulting from processing the various parts of the HTTP transaction (HTTP request 551, database query 552, and HTTP response 553) to be used when the various parts of the HTTP transaction occur.

### Event Profile

An event profile binds a set of filters to one of the potential final classification states desired. For example, if the objective is to classify an HTTP transaction as a performance outlier, an event profile that defines permutation of filters to capture a timestamp that crosses a certain threshold can be specified. Similarly, if the objective is to classify an HTTP transaction as malicious (ATTACK/THREAT) or BENIGN, then an event profile defines a permutation of filters which, when met, would classify an HTTP transaction as an ATTACK/THREAT or BENIGN.

An event profile defines a sequence of filters, which may become active in a pre-defined order or any order. An event profile becomes active whenever all the filters in that event profile become active. In an embodiment, as HTTP transaction messages are received, the HTTP transaction messages go through a set of filters defined in the event profile, and an active state of these filters accordingly gets established. The determination of event occurrence (e.g., event classification as attack/threat or benign) is based on the combination of filters (typically including different message types) becoming active in a certain order. An event profile provides a mechanism for defining this grouping of filters.

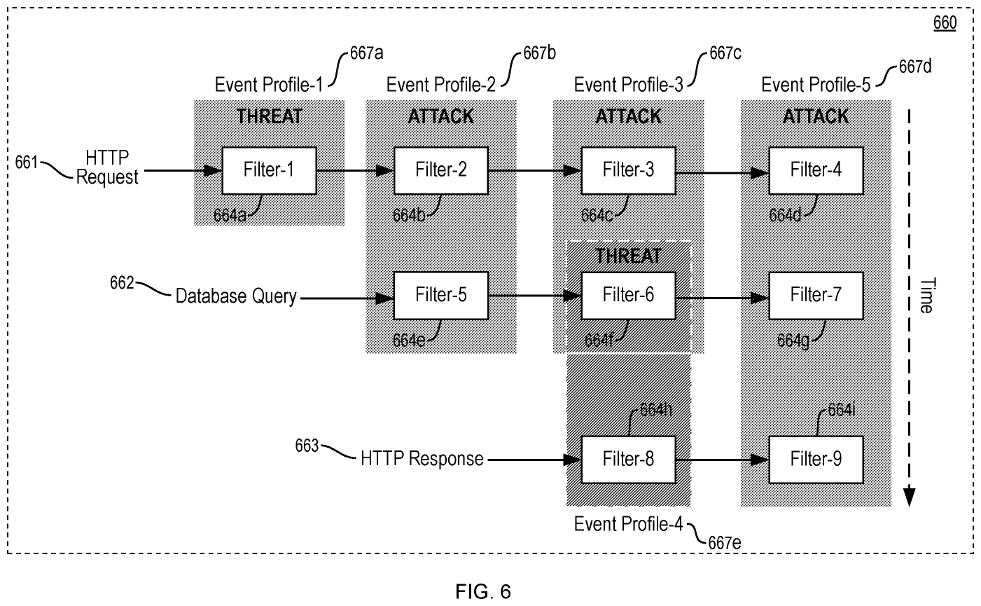

The system 660 in FIG. 6 is an example where the goal is to classify an HTTP transaction (which includes the HTTP request 661, database query 662, and HTTP response 663) as malicious (ATTACK/THREAT) or BENIGN.

In the system 660 the vertical cross section of filters represents event profiles 667a-e which emit desired final classification states. The system, i.e., engine, 660 starts with a default classification state of an HTTP transaction (the HTTP request 661, database query 662, and HTTP response 663) as BENIGN, but may promote final classification state to THREAT or ATTACK if a corresponding event profile becomes active.

In FIG. 6 there are nine filters, namely filters 664a-i. There are five event profiles, event profile 667a (filter 664a, THREAT), event profile 667b (filter 664b, filter 664e, ATTACK), event profile 667c (filter 664c, filter 664f, ATTACK), event profile 667e (filter 664f, filter 664h, THREAT) and event profile 667d (filter 664d, filter 664g, filter 664i, ATTACK). In the system 660, the HTTP request message 661 is passed through filters 664a-d. Database query message 662 is passed through filters 664e-g and HTTP response message 663 is passed through filters 664h-i.

To illustrate functionality of the system 660, consider the example of the event profile 667b. Event profile 667b is defined below:
event_profile EventProfile2 [ATTACK, order (fixed, filter2, filter5)]
   As such, the event profile 667b is activated when filter2 664b (which acts on HTTP request 661) and filter5 664e (which acts on database query 662) become active in order, i.e., filter2 664b is activated and then filter5 664e is activated.

It is noted that while the system 660 is described as being configured to classify an HTTP transaction as malicious or benign, embodiments are not so limited and, instead, embodiments can be configured to determine if HTTP transactions correspond with any user defined qualities.

For example, the system 770 is configured to classify an HTTP transaction (which includes the HTTP request 771, SQL event 772, and HTTP response 773) as a performance outlier and, such classifications may result in detection of one or more performance degradation events.

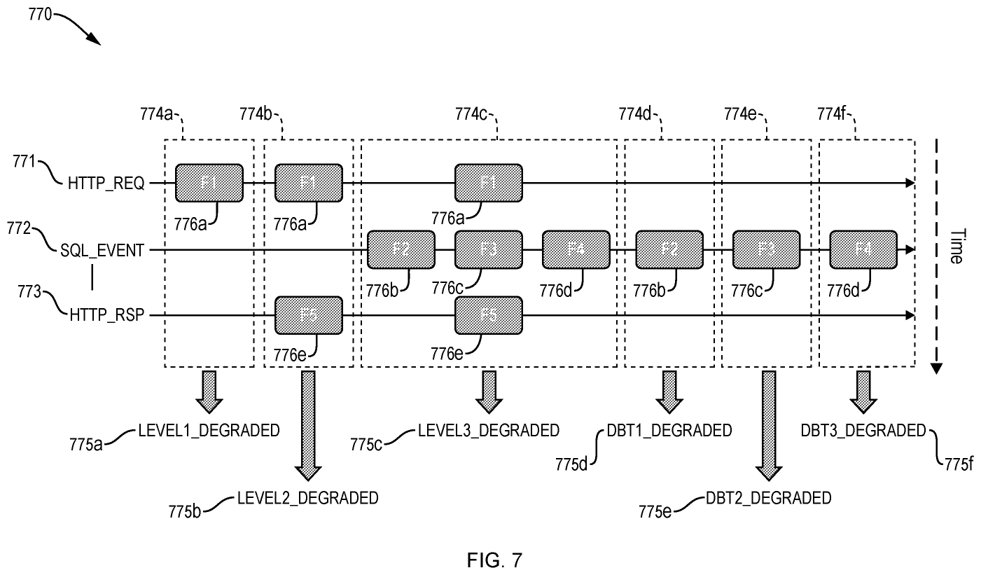

In the example of FIG. 7, performance of a web application is being evaluated. The example web application uses a SQL database and has three main tables (referred to as DBT1, DBT2, DBT3). The objective of the system 770 is to assess the web application and database access performance on a continuous basis.

In such an implementation, the system, i.e., engine, 770 starts with a default classification state of an HTTP transaction (the HTTP request 771, SQL event 772, and HTTP response 773) as NOT_DEGRADED, and may promote the default classification to one or more of the final degraded classification states 775a-f. In the system 770 the vertical cross section of filters represents event profiles 774a-f which emit desired final classification states LEVEL1_DEGRADED 775a, LEVEL2_DEGRADED 775b, LEVEL3_DEGRADED 775c, DBT1_DEGRAED 775d, DBT2_DEGRADED 775e, and DBT3_DEGRADED 775f, if a corresponding event profile 774a-f becomes active.

The system 770 implements five defined filters 776a-e.

The filter 776a, HTTP_REQ_PERF_FILTER (F1), reads special Key-Val pairs in HTTP Request 771 telemetry messages that specify timestamp (ts_http_req_start) when application logic starts processing HTTP Request 771 and timestamp (ts_http_req_end) when application logic finishes processing HTTP Request 771. This filter 776a has pre-programmed threshold value (ts_http_req_thresh) of maximum processing latency. If (ts_http_req_end−ts_http_req_start)>ts_http_req_thresh, the filter 776a gets activated.

Filter 776b, DBT1_PERF_FILTER (F2), reads special Key-Val pairs in SQL Event 772 telemetry message that specify timestamp (ts_dbt1_start) when application logic starts accessing DB Table 1 and timestamp (ts_dbt1_end) when application logic finishes accessing DB Table 1 and gets the results back. This filter 776b has pre-programmed threshold value (ts_dbt1_thresh) of maximum processing latency of accessing DB Table1. If (ts_dbt1_end−ts_dbt1_start)>ts_dbt1_thresh, the filter 776b is activated. This filter 776b also requires a special Key-Val pair in SQL Event telemetry message 772 that identifies SQL table accessed as Table-1.

The filter 776c, DBT2_PERF_FILTER (F3), reads special Key-Val pairs in SQL Event telemetry message 772 that specify timestamp (ts_dbt2_start) when application logic starts accessing DB Table 2 and timestamp (ts_dbt2_end) when application logic finishes accessing DB Table 2 and gets the results back. Filter 776c has pre-programmed threshold value (ts_dbt2_thresh) of maximum processing latency of accessing DB Table2. If (ts_dbt2_end−ts_dbt2_start)>ts_dbt2_thresh, this filter 776c is activated. This filter 776c also requires a special Key-Val pair in SQL Event telemetry message 772 that identifies the SQL table accessed as Table-2.

Filter 776d, DBT3_PERF_FILTER (F4), reads special Key-Val pairs in SQL Event telemetry message 772 that specify timestamp (ts_dbt3_start) when application logic starts accessing DB Table 3 and timestamp (ts_dbt3_end) when application logic finishes accessing DB Table 3 and gets the results back. This filter 776d has pre-programmed threshold value (ts_dbt3_thresh) of maximum processing latency of accessing DB Table3. If (ts_dbt3_end−ts_dbt3_start)>ts_dbt3_thresh, this filter 776d will get activated. The filter 776d also requires a special Key-Val pair in SQL Event telemetry message 772 that identifies SQL table accessed as Table-3.

Filter 776e, HTTP_RSP_PERF_FILTER (F5), reads special Key-Val pairs in HTTP Response telemetry message 773 that specify timestamp (ts_http_rsp_start) when application logic starts processing HTTP Response 773 and timestamp (ts_http_rsp_end) when application logic finishes processing and generating HTTP Response 773. This filter 776e has pre-programmed threshold value (ts_http_rsp_thresh) of maximum processing latency. If (ts_http_rsp_end−ts_http_rsp_start)>ts_http_rsp_thresh, this filter 776e gets activated.

The following are possible events 775a-f of interest in the system 770: Event LEVEL1 DEGRADED (order (fixed, HTTP_REQ_PERF_FILTER)) (775a); Event LEVEL2 DEGRADED (order (any, HTTP_REQ_PERF_FILTER, HTTP_RSP_PERF_FILTER)) (775b); Event LEVEL3_DEGRADED (order (any, HTTP_REQ_PERF_FILTER, HTTP_RSP_PERF_FILTER, DB1_PERF_FILTER, DB2_PERF_FILTER, DB3_PERF_FILTER)) (775c); Event DBT1_DEGRADED (order (fixed, DB1_PERF_FILTER)) (775d); Event DBT2_DEGRADED (order (fixed, DB2_PERF_FILTER)) (775e); and Event DBT3_DEGRADED (order (fixed, DB3 PERF_FILTER)) (775f).

To illustrate operation of the system 770, consider the example of event profile 774c, which is attempting to determine if the HTTP transaction (HTTP request 771, SQL event 772, and HTTP response 773), is degraded. Event profile 774c is defined below:
Event LEVEL3_DEGRADED (order (any, HTTP_REQ_PERF_FILTER, HTTP_RSP_PERF_FILTER, DB1_PERF_FILTER, DB2_PERF_FILTER, DB3_PERF_FILTER))

As such, the event profile 774c is activated when F1 776a (which acts on HTTP request 771); F2 776b, F3 776c, and F4 776d (which act on SQL event 772) become active; and F5 776e (which acts on HTTP response 773) are activated, in any order.

### Feature

A feature is a set of event profiles. A feature set is applicable for a given URL or a set of URLs. According to an embodiment, whenever an HTTP transactional message is received for a URL, it goes through the feature set associated with that URL. In the example below, a Feature named “Assess_Perf myURL” is defined for URL http://myspace.com:

Feature “Assess_Perf myURL”:
http://myspace.com {

| | |
|---|---|
| • | Event LEVEL1_DEGRADED (order (fixed, HTTP_REQ_PERF_FILTER)) |
| • | Event LEVEL2_DEGRADED (order (any, HTTP_REQ_PERF_FILTER, |
| | HTTP_RSP_PERF_FILTER)) |
| • | Event LEVEL3_DEGRADED (order (any, HTTP_REQ_PERF_FILTER, |
| | HTTP_RSP_PERF_FILTER, DB1_PERF_FILTER, DB2_PERF_FILTER, |
| | DB3_PERF_FILTER)) |
| • | Event DBT1_DEGRADED (order (fixed, DB1_PERF_FILTER)) |
| • | Event DBT2_DEGRADED (order (fixed, DB2_PERF_FILTER)) |
| • | Event DBT3_DEGRADED (order (fixed, DB3_PERF_FILTER)) |
| } | |

This example feature contains six event profiles that detect different levels of potential performance degradation in a functional application. For instance, event LEVEL1_DEGRDED may identify that only HTTP_REQ message processing is degrading, event LEVEL2 DEGRADED may detect degradation in both HTTP_REQ and HTTP_RSP messages of the HTTP Transaction in question on http://myspace.com, etc.

While the foregoing example feature is directed to performance evaluation, embodiments can define features toward any desired event detection. For instance, an example Feature named “Secure myURL” directed toward malicious event detection is defined for URL http://myspace.com:

| Feature “Secure myURL”: | |
|---|---|
| • | http://myspace.com { |
| | Event event1 (attack, order(fixed, filter1, filter2)); |
| | Event event2 (attack, order(fixed, filter1, filter2, filter3)); |
| | Event event3 (attack, order(fixed, filter1, filter4, filter5)); |
| | Event event4 (attack, order(fixed, filter6, filter7)); |
| | Event event5 (attack, order(fixed, filter6, filter8)); |
| } | |

This example feature contains five event profiles that detect certain kinds of attacks. For instance, event1 may identify a cross site script attack, event2 may detect a SQL injection attack on http://myspace.com, etc.

### Namespace

A namespace defines a correlated set of features which reside within a namespace. A namespace is a logical grouping of one or more features. By grouping features in specific namespaces, embodiments facilitate managing each namespace separately. Examples where such a logical grouping of features is applicable is a service provider rolling out web application security and/or performance monitoring services to multiple clients. Namespaces can be employed to provide a mechanism to roll out different sets of features to different clients. Below is an example namespace definition for a security service:

```
Namespace:
Customer-1 {
[“Secure myURL”, “Secure remoteLogin”];
}
Customer-2 {
  [“APM webapp”];
}
    Below is an example namespace definition for performance monitoring:
Namespace:
Customer-1 {
[“Monitor_Perf myURL1”, “Monitor_Perf myURL2”];
}
Customer-2 {
  [“APM webapp”];
}
```

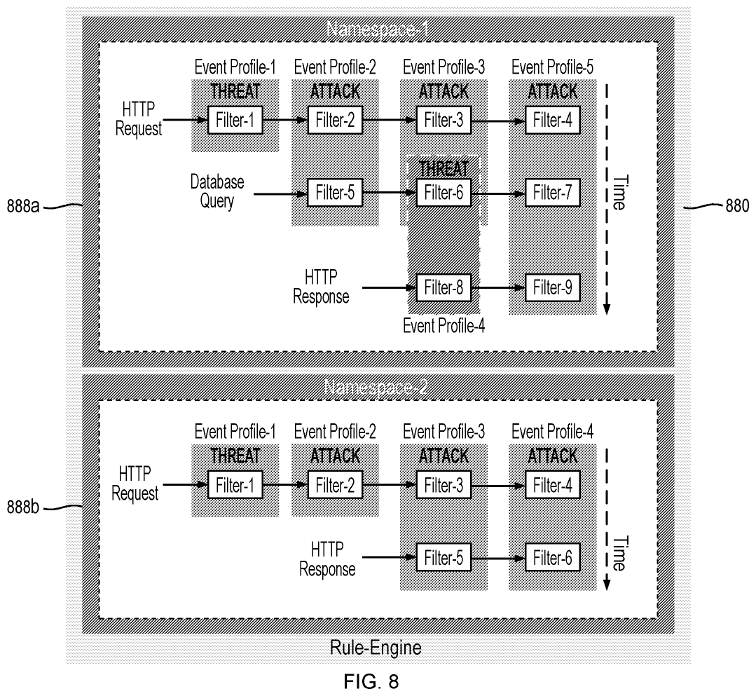

FIG. 8 shows an example system 880 that includes the namespaces 888a-b. The namespaces 888a-b create a logical separation of workload in the rule-engine 880.

Embodiments utilize rule definitions to implement telemetry data processing. In an embodiment, the rules define the functionality of the system, e.g., rule engine or finite state automaton, for processing telemetry data. The rules can define filters, event profiles, features, and/or namespaces for processing telemetry data. Moreover, the rules can define which filters, including which filter types, to use depending on the data types being processed, e.g., deep-type data or perimeter-type data. Below is an example rule definition. The below example rule is written to implement a Reflected-XSS and SQL-Injection security feature, i.e., determine if a Reflected-XSS and SQL-Injection attack is caused by an HTTP transaction.

```
filter httpreq_filter(life = uuid, msg = HTTP_REQ, type = util ) {
  /**
  * This filter extracts HTTP req key/val pairs, and exports it so that
  * other filter can use it
  */
  hreq = keyval(HTTP_REQ, KEY_ALL, --);
  export(hreq);
  return hreq;
}
filter httpreq_filter_sql(life = uuid, msg = HTTP_REQ, dbname-dbsql) {
  /**
  * If any SQL keyword pattern is found in HTTP req, save the pattern and export
  * will be used by other filters.
  */
  sqlmatch = load(“sql.gf”);
  export(sqlmatch);
  return sqlmatch;
}
filter sqlinjection_filter_attack(life=message, msg = DB_QUERY) {
  /**
  * Algorithm -
  * 1. Check if SQL keywork pattern was found in http req, by importing “sqlmatch”
  * 2. Extracts all user input from SQL query (by parsing SQL query through true
parser)
  * 3. If all user input from SQL query is also present in sqlmatch, and it's not exact
match
  * - i.e. if its substring match only, no exact match, call it out as attack.
  */
  import httpreq_filter (hreq);
  import httpreq_filter_sql (sqlmatch);
  debug(hreq);
  debug(sqlmatch);
  sqry = keyval(DB_QUERY, KEY_ALL, --);
  debug(sqry);
  subreq = match(sqry, hreq);
  debug(subreq);
  /**
  sqlmatch will have more than one value, this will match all the value
  with SQL query, and only keep those value which are used in SQL query.
  first argument as ‘—’ signifies to match it (sqlmatch) with all sql query keyval.
  */
  hval = match(—, sqlmatch);
  debug(hval);
  /**
  This will match hval from hreq, and save full input as matched string
  */
  psqlmatch = match(hreq, hval, full);
  debug(psqlmatch);
  if(psqlmatch) {
    libattack = libinjection(psqlmatch);
  }
  debug(libattack);
  origquery = keyval(DB_QUERY, KEY, “_sql_”, msg);
  p1 = replace(psqlmatch, “ ”, “”);
  check1 = match(origquery, p1);
  debug(check1);
  check2 = match(origquery, psqlmatch);
  debug(check2);
  check = check1 | check2;
  debug(check);
  cln_psqlmatch = replace(psqlmatch, “\\”, “”);
  debug(cln_psqlmatch);
  cln_psqlmatch = replace(cln_psqlmatch, “\””, “”);
  debug(cln_psqlmatch);
  cln_psqlmatch = replace(cln_psqlmatch, “′”, “”);
  debug(cln_psqlmatch);
  cln_sqry = replace(sqry, “\\”, “”);
  debug(cln_sqry);
  cln_sqry = replace(cln_sqry, “\””, “”);
  debug(cln_sqry);
  cln_sqry = replace(cln_sqry, “′”, “”);
  debug(cln_sqry);
  submatch = match(cln_psqlmatch, cln_sqry);
  debug(submatch);
  exactmatch = match(cln_psqlmatch, cln_sqry, exact);
  debug(exactmatch);
  noexactmatch = ! exactmatch;
  sqlattack = submatch & noexactmatch;
  debug(sqlattack);
  sqlinjection_attack1 = sqlattack & check;
  debug(sqlinjection_attack1);
  sqlinjection_attack = union(sqlinjection_attack1, libattack);
  debug(sqlinjection_attack);
  export(sqry, submatch, hval, psqlmatch);
  return sqlinjection_attack;
}
filter sqlexception_filter(life=message, msg = SQLEXCEPTION) {
  exceptionmsg = keyval(SQLEXCEPTION, key, “_exception_msg_”, msg);
  origquery = keyval(SQLEXCEPTION, KEY, “_sql_”, msg);
  export(exceptionmsg, origquery);
  return exceptionmsg;
}
report reportsqlexception desc: “SQLi” (sqlexceptionevent) {
  import sqlexception_filter (exceptionmsg, origquery);
  //“Description - ” : “Sql exception detected”,
  “Exception reason: ” : exceptionmsg,
  : origquery
}
report reportsql desc: “SQLi” (sqlevent) {
  import sqlinjection_filter_attack (submatch, sqry, hval, psqlmatch);
  //“Description - ” : “Sql injection attack detected”,
  : psqlmatch
}
filter httpreq_filter_xss_1(life = uuid, msg= HTTP_REQ, dbname=dbxss1) {
  catanfq = load(“xssANFQ.gf”, full);
  debug(catanfq);
  catd = load(“xssD.gf”);
  debug(catd);
  catafq = load(“xssAFQ.gf”);
  debug(catafq);
  /* find subset based on key (i.e. same key) */
  cna = subsetkey(catanfq, catd);
  debug(cna);
  /* find subset based on key (i.e. same key) */
  ca = subsetkey(catafq, catd);
  debug(ca);
  /* Get union of cna and ca */
  catad = union(cna, ca);
  debug(catad);
  export(catad);
  return catad;
}
filter httpreq_filter_xss_2(life = uuid, msg= HTTP_REQ, dbname=dbxss2) {
  catbnfq = load(“xssBNFQ.gf”, full);
  debug(catbnfq);
  catbfq = load(“xssBFQ.gf”);
  debug(catbfq);
  catb = union(catbfq, catbnfq);
  debug(catb);
  export(catb);
  return catb;
}
filter httpreq_filter_xss_3(life = uuid, msg= HTTP_REQ, dbname=dbxss3) {
  catc = load(“xssC.gf”);
  debug(catc);
  export(catc);
  return catc;
}
filter httpreq_filter_xss(life = uuid, msg = HTTP_REQ) {
  import httpreq_filter_xss_1 (catad);
  import httpreq_filter_xss_2 (catb);
  import httpreq_filter_xss_3 (catc);
  xssmatch = union(catc, catad, catb);
  debug(xssmatch);
  export(xssmatch);
  return xssmatch;
}
filter reflected_xss_filter(life=message, msg = HTTP_RES) {
  /**
  * Algorithm -
  * 1. Check if XSS pattern was found in HTTP req (xssmatch from previous filter will
  be active)
  * 2. if same patterns are also found in HTTP res, then it's a reflective XSS attack if
  http_status is “0” else
  * its threat
  */
  import httpreq_filter_xss (xssmatch);
  debug(xssmatch);
  hres = keyval(HTTP_RES, KEY_ALL, --);
  debug(hres);
  xss_common = match(hres, xssmatch);
  httpstatus = keyval(HTTP_RES, KEY, “_http_status_”, msg);
  debug(xss_common);
  debug(httpstatus);
  export(httpstatus, xss_common);
  return xss_common;
}
filter reflected xss_filter_threat(life = message, msg = HTTP_RES) {
  /**
  * Algorithm -
  * 1. Check if XSS pattern was found in HTTP req (xssmatch from previous filter will
  be active)
  * 2. if same patterns are also found in HTTP res, then it's a reflective XSS attack if
  http_status is “0” else
  * its threat
  */
  import reflected_xss_filter (httpstatus);
  code = constant(“0”);
  exec = unequal(code, httpstatus);
  debug(exec);
  return exec;
}
filter reflected xss_filter_attack(life = message, msg = HTTP_RES) {
  /**
  * Algorithm -
  * 1. Check if XSS pattern was found in HTTP req (xssmatch from previous filter will
  be active)
  * 2. if same patterns are also found in HTTP res, then it's a reflective XSS attack.
  */
  import reflected_xss_filter (httpstatus);
  code = constant(“0”);
  exec = equal(code, httpstatus);
  debug(exec);
  return exec;
}
filter httpres_filter_xss_1(life = uuid, msg= HTTP_RES, dbname=dbxss1) {
  catanfq = load(“xssANFQ.gf”, full);
  debug(catanfq);
  catd = load(“xssD.gf”);
  debug(catd);
  catafq = load(“xssAFQ.gf”);
  debug(catafq);
  cna = subsetkey(catanfq, catd);
  ca = subsetkey(catafq, catd);
  catad = union(cna, ca);
  export(catad);
  return catad;
}
filter httpres_filter_xss_2(life = uuid, msg= HTTP_RES, dbname=dbxss2) {
  catbnfq = load(“xssBNFQ.gf”, full);
  debug(catbnfq);
  catbfq = load(“xssBFQ.gf”);
  debug(catbfq);
  catb = union(catbfq, catbnfq);
  debug(catb);
  export(catb);
  return catb;
}
filter httpres_filter_xss_3(life = uuid, msg= HTTP_RES, dbname=dbxss3) {
  catc = load(“xssC.gf”);
  debug(catc);
  export(catc);
  return catc;
}
filter httpres_filter_xss(life = uuid, msg = HTTP_RES) {
  import httpres_filter_xss_1 (catad);
  import httpres_filter_xss_2 (catb);
  import httpres_filter_xss_3 (catc);
  xssmatch = union(catc, catad, catb);
  debug(xssmatch);
  export(xssmatch);
  return xssmatch;
}
report reportxssthreat desc: “ReflectedXSS” (xssevent1) {
  import reflected_xss_filter(xss_common);
  //“Description - ” : “Reflected XSS threat detected”,
  :xss_common
}
report reportxssattack desc: “ReflectedXSS” (xssevent2) {
  import reflected_xss_filter(xss_common);
  //“Description - ” : “Reflected XSS attack detected”,
  :xss_common
}
namespace: virsec URL(any)
{
  event sqlevent (ATTACK, order(fixed, httpreq_filter, httpreq_filter_sql,
sqlinjection_filter_attack));
  event sqlexceptionevent (THREAT, order(fixed, sqlexception_filter));
  event xssevent1 (THREAT, order(fixed,
    ANY (httpreq_filter_xss_1, httpreq_filter_xss_2,
    httpreq_filter_xss_3),httpreq_filter_xss, reflected_xss_filter,
    reflected_xss_filter_threat));
  event xssevent2 (ATTACK, order(fixed,
    ANY (httpreq_filter_xss_1, httpreq_filter_xss_2, httpreq_filter_xss_3),
    httpreq_filter_xss, reflected_xss_filter, reflected_xss_filter_attack));
  FEATURE featid:1 sqlfeature (sqlevent, sqlexceptionevent);
  FEATURE featid:2 xssfeature (xssevent1, xssevent2);
}
```

Embodiments provide numerous benefits over existing methods. For instance, an embodiment provides a generic Rule-Engine that allows instantiation of any new processing of HTTP transactional telemetry data without performing a software upgrade. Another embodiment implements a generic Rule-Engine architecture based on a set of pattern-based filters that act on telemetry data derived from HTTP transactions occurring on web/application servers with an objective to classify HTTP transactions to any arbitrary finite set of outcomes. Moreover, another generic Rule-Engine architecture embodiment implements a finite state automaton where state information can be shared across asynchronous events spanning across any arbitrary context (such as a single transaction or a single session).

Embodiments allow adaptive selection of rule filters based on deep events received from an agent instrumenting a given web application. This adaptation allows migration from perimeter filters to deep filters on a per event, e.g., vulnerability (security control), basis for better efficacy of event, e.g., attack/threat, detection. This adaptation to the rule engine functionality described in the '225 patent application is completely autonomous and does not require any external intervention.

In the '225 patent application, multiple messages, i.e., pieces of telemetry data, are often needed for event occurrence determinations. However, the multiple messages are not always available. In contrast to the '225 patent application, which would require all of the messages, embodiments of the present disclosure operate without such a requirement. Embodiments provide such functionality by adaptively switching between deep and perimeter filters depending upon the data that is available.

Existing methods fail to provide such functionality. For example, there are a few Web Application Firewall projects, such as Sqreen (https://docs.sqreen.com/), that implement an adaptive rule set to detect web application attacks. There are some details of this “Smart Stack Detection” mechanism described at https://docs.sqreen.com/protection/introduction/. Problematically, the Sqreen approach to adapt a rule based on depth of instrumentation follows a proprietary rule grammar, and lacks the efficacy and runtime programmability of both the perimeter and deep filters described herein.

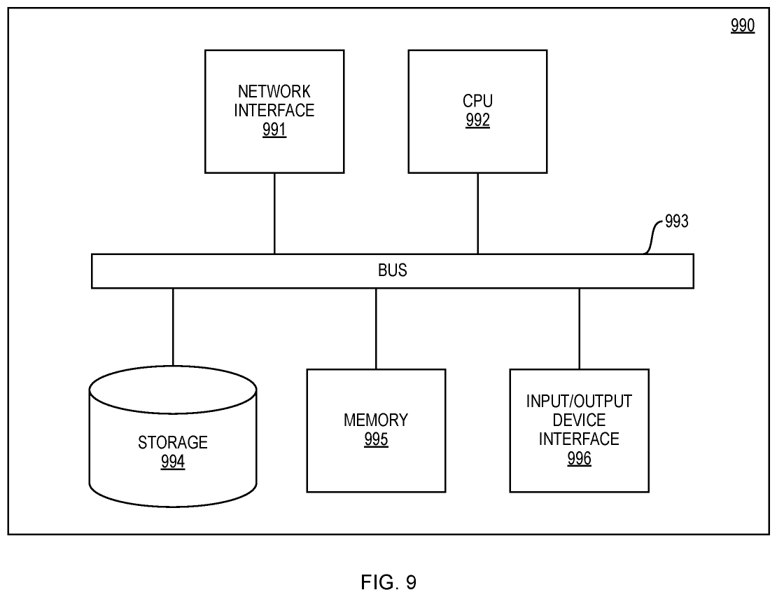

FIG. 9 is a simplified block diagram of a computer-based system 990 that may be used to determine event occurrence based on telemetry data according to any variety of the embodiments of the present disclosure described herein. The system 990 comprises a bus 993. The bus 993 serves as an interconnect between the various components of the system 990. Connected to the bus 993 is an input/output device interface 996 for connecting various input and output devices such as a keyboard, mouse, touch screen, display, speakers, etc. to the system 990. A central processing unit (CPU) 992 is connected to the bus 993 and provides for the execution of computer instructions. Memory 995 provides volatile storage for data used for carrying out computer instructions. Storage 994 provides non-volatile storage for software instructions, such as an operating system (not shown). The system 990 also comprises a network interface 991 for connecting to any variety of networks known in the art, including wide area networks (WANs) and local area networks (LANs).

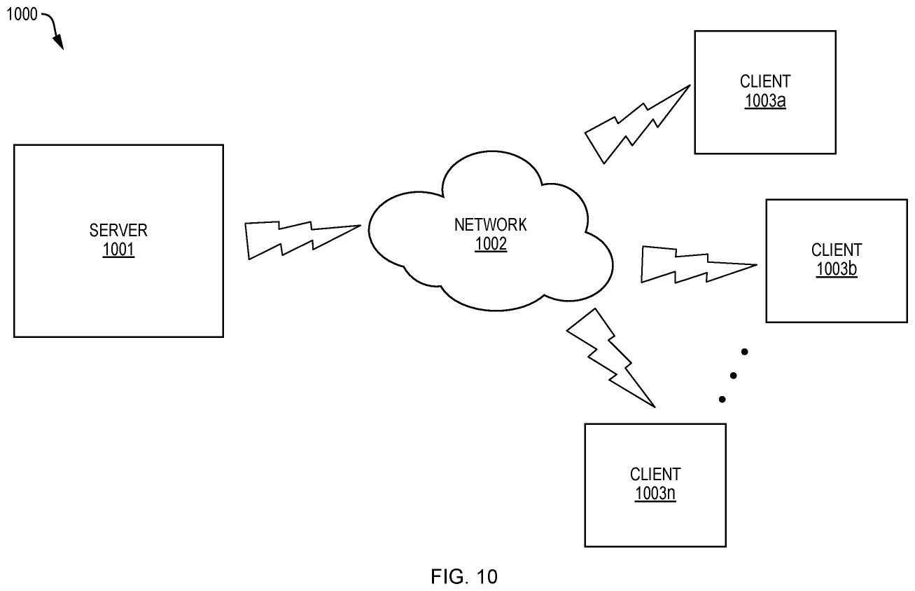

It should be understood that the example embodiments described herein may be implemented in many different ways. In some instances, the various methods and machines described herein may each be implemented by a physical, virtual, or hybrid general purpose computer, such as the computer system 990, or a computer network environment such as the computer environment 1000, described herein below in relation to FIG. 10. The computer system 990 may be transformed into the machines that execute the methods described herein, for example, by loading software instructions implementing method 100 into either memory 995 or non-volatile storage 994 for execution by the CPU 992. One of ordinary skill in the art should further understand that the system 990 and its various components may be configured to carry out any embodiments or combination of embodiments of the present disclosure described herein. Further, the system 990 may implement the various embodiments described herein utilizing any combination of hardware, software, and firmware modules operatively coupled, internally, or externally, to the system 990.

FIG. 10 illustrates a computer network environment 1000 in which an embodiment of the present disclosure may be implemented. In the computer network environment 1000, the server 1001 is linked through the communications network 1002 to the clients 1003a-n. The environment 1000 may be used to allow the clients 1003a-n, alone or in combination with the server 1001, to execute any of the embodiments described herein. For non-limiting example, computer network environment 1000 provides cloud computing embodiments, software as a service (SAAS) embodiments, and the like.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A computer-implemented method comprising:
receiving telemetry data and a rule associated with the telemetry data, the rule defining at least one perimeter filter and at least one deep filter for processing the telemetry data;
modifying a rule engine in accordance with the received rule, the modified rule engine configured to automatically switch between the at least one perimeter filter and the at least one deep filter; and
processing the received telemetry data with the modified rule engine to determine occurrence of an event.

2. The method of claim 1 wherein the telemetry data is based on at least one of: a Hypertext Transfer Protocol (HTTP) transaction and processing the HTTP transaction.

3. The method of claim 1 wherein the telemetry data is based on multiple HTTP transactions.

4. The method of claim 1 wherein the telemetry data includes at least one of: perimeter-type data and deep-type data.

5. The method of claim 4 wherein processing the received telemetry data comprises:
selecting one or more filters, from amongst the at least one perimeter filter and the at least one deep filter, based on data types comprising the telemetry data; and
processing the telemetry data with the selected one or more filters.

6. The method of claim 5 wherein selecting the one or more filters comprises:
responsive to the telemetry data including only the perimeter-type data, selecting both the at least one perimeter filter and the at least one deep filter; and
responsive to the telemetry data including only the deep-type data or both the perimeter-type data and the deep-type data, disabling the at least one perimeter filter and selecting the at least one deep filter.

7. The method of claim 1 wherein processing the received telemetry data with the modified rule engine comprises:
identifying which of the at least one perimeter filter and the at least one deep filter is activated in processing the received telemetry data; and
determining occurrence of the event based on the identified activated filters.

8. The method of claim 1 wherein the rule is constructed and defined in accordance with a grammar.

9. The method of claim 1 wherein the event is:
a performance degradation;
a security breach;
a hijacked session; or
a behavior defined by the rule.

10. The method of claim 1 wherein the processing determines occurrence of the event in real-time.

11. A system comprising:
a processor; and
a memory with computer code instructions stored thereon, the processor and the memory, with the computer code instructions, being configured to cause the system to:
receive telemetry data and a rule associated with the telemetry data, the rule defining at least one perimeter filter and at least one deep filter for processing the telemetry data;
modify a rule engine in accordance with the received rule, the modified rule engine configured to automatically switch between the at least one perimeter filter and the at least one deep filter; and
process the received telemetry data with the modified rule engine to determine occurrence of an event.

12. The system of claim 11 wherein the telemetry data is based on at least one of: a Hypertext Transfer Protocol (HTTP) transaction and processing the HTTP transaction.

13. The system of claim 11 wherein the telemetry data is based on multiple HTTP transactions.

14. The system of claim 11 wherein the telemetry data includes at least one of: perimeter-type data and deep-type data.

15. The system of claim 14 wherein, in processing the received telemetry data, the processor and the memory, with the computer code instructions, are further configured to cause the system to:
select one or more filters, from amongst the at least one perimeter filter and the at least one deep filter, based on data types comprising the telemetry data; and
process the telemetry data with the selected one or more filters.

16. The system of claim 15 wherein, in selecting the one or more filters, the processor and the memory, with the computer code instructions, are configured to cause the system to:
responsive to the telemetry data including only the perimeter-type data, select both the at least one perimeter filter and the at least one deep filter; and
responsive to the telemetry data including only the deep-type data or both the perimeter-type data and the deep-type data, disable the at least one perimeter filter and select the at least one deep filter.

17. The system of claim 11 wherein, in processing the received telemetry data with the modified rule engine, the processor and the memory, with the computer code instructions, are further configured to cause the system to:
identify which of the at least one perimeter filter and the at least one deep filter is activated in processing the received telemetry data; and
determine occurrence of the event based on the identified activated filters.

18. The system of claim 11 wherein the rule is constructed and defined in accordance with a grammar.

19. The system of claim 11 wherein the event is:
a performance degradation;
a security breach;
a hijacked session; or
a behavior defined by the rule.

20. A non-transitory computer program product, the computer program product executed by a server in communication across a network with one or more clients and comprising:
a computer readable medium, the computer readable medium comprising program instructions, which, when executed by a processor, causes the processor to:
receive telemetry data and a rule associated with the telemetry data, the rule defining at least one perimeter filter and at least one deep filter for processing the telemetry data;
modify a rule engine in accordance with the received rule, the modified rule engine configured to automatically switch between the at least one perimeter filter and the at least one deep filter; and
process the received telemetry data with the modified rule engine to determine occurrence of an event.
